(19) United States
(12) Patent Application Publication
(10) Pub. No.: US 2009/0313629 A1
(43) Pub. Date: Dec. 17, 2009

(54) Task processing system and task processing method

(75) Inventor: Hiroyuki Azuma, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/457,291

(22) Filed: Jun. 5, 2009

(30) Foreign Application Priority Data
Jun. 17, 2008 (JP) 158277/2008

(51) Int. Cl. G06F 1/04; G06F 9/46

(52) U.S. Cl. 718/102; 713/600

(57) ABSTRACT

Provided are a task processing system and a task processing method that can reduce power consumption and prevent overhead or processing load from increasing even with a system which performs frequency switching frequently. A main processor determines at least one of tasks to be executed by a sub processor in each of a plurality of time segment each having a predetermined length and determines, by the end of an nth (n is an integer that satisfies n≧1) time segment, a clock frequency necessary for executing the task within an (n+1)th time segment based on information of a required number of cycles for the task to be executed by the sub processor in the (n+1)th time segment. The clock generation/control circuit supplies, in the (n+1)th time segment, to the sub processor a clock signal according to the clock frequency determined by the main processor in the nth time segment.

### BACKGROUND OF THE INVENTION

1. Field of the Invention

The present invention relates to a task processing system and a task processing method, particularly to a task processing system including a main processor and a sub processor controlled by the main processor, and a task processing method.

2. Description of the Related Art

Some task processing systems mounted to electronic devices such as mobile phones each include a main processor, a sub processor controlled by the main processor, and a clock supply circuit that supplies a clock signal to the sub processor. The main processor assigns a task to be executed by the sub processor to each of a plurality of time segments each having a predetermined length.

Conventionally, an operation frequency allowing maximum expectable processings to be executed simultaneously has been determined in advance at the design stage. The clock supply circuit has supplied to the sub processor a clock signal based on the operation frequency thus determined in advance. In other words, the clock supply circuit has supplied to the sub processor a clock signal with a sufficient operation margin being secured for the system to properly operate even when a maximum expectable processing load is applied. Therefore, the clock signal of a frequency higher than necessary is supplied to the sub processor even when the actual processing load is small in a certain time segment, causing electric power to be wasted.

To address this problem, in Japanese Patent Application Publication No. Hei 10-078828, the operation frequency is determined dynamically based on a processing amount in the most recent time segment. This is performed for preventing supply of the clock signal based on the operation frequency with a sufficient operation margin being secured.

However, the technique described in Japanese Patent Application Publication No. Hei 10-078828 does not achieve a flexible response to an increase or decrease in the processing amount in the next time segment since the operation frequency is determined based on the processing amount in the most recent time segment.

Also, in the technique of Japanese Patent Application Publication No. Hei 10-078828, a frequency dividing ratio is determined for every interruption type in the event of an interruption. Therefore, switching of frequency is performed frequently in a system in which interruptions occur frequently at short intervals (several tens to several hundreds of microseconds) such as a mobile phone (TDMA) system. Accordingly, increases in overhead and processing load become problems.

### SUMMARY

A task processing system according to a first aspect of the present invention includes: a main processor; a sub processor controlled by the main processor; and a clock controller that supplies a clock signal to the sub processor. In the task processing system, the main processor determines a task to be executed by the sub processor in each of a plurality of time segments each having a predetermined length, and determines, by an end of an nth (n is an integer that satisfies n≧1) time segment, an operation frequency necessary for executing the task within an (n+1)th time segment, on the basis of information of a required number of cycles for the task to be executed by the sub processor in the (n+1)th time segment, and the clock controller supplies, in the (n+1)th time segment, to the sub processor a clock signal according to the operation frequency determined by the main processor in the nth time segment.

A task processing method according to a second aspect of the present invention is a task processing method for a task processing system, the system including a main processor; a sub processor controlled by the main processor; and a clock controller that supplies a clock signal to the sub processor. The task processing method includes the steps of causing the main processor to determine a task to be executed by the sub processor in each of a plurality of time segments each having a predetermined length, and to determine, by an end of an nth (n is an integer that satisfies n≧1) time segment, an operation frequency necessary for executing the task within an (n+1)th time segment, on the basis of information of a required number of cycles for the task to be executed by the sub processor in the (n+1)th time segment; and causing the clock controller to supply, in the (n+1)th time segment, to the sub processor a clock signal according to the operation frequency determined by the main processor in the nth time segment.

In the first aspect and the second aspect of the present invention, the main processor determines, by the end of the nth time segment, the operation frequency which the sub processor needs to execute the task within the (n+1)th time segment. The clock controller supplies the clock signal to the sub processor in the (n+1)th time segment, the clock signal according to the operation frequency determined by the main processor in the nth time segment. That is, the operation frequency is determined dynamically depending on the processing amount of the task to be executed in each time segment. This enables a flexible response to an increase or decrease in the processing amount in the next time segment. Also, this securely prevents supply of the clock signal based on an operation frequency with an operation margin being excessively secured. Accordingly, power consumption can be reduced.

Moreover, an increase in overhead or processing load can be prevented even in a system that frequently performs switching of frequency since a frequency dividing ratio is not determined for every interruption type.

With the present invention, power consumption can be reduced and an increase in overhead or processing load can be prevented even in a system that frequently performs switching of frequency.

### BRIEF DESCRIPTION OF THE DRAWINGS

FIG. 1 is a block diagram showing a schematic configuration of a task processing system according to an embodiment of the present invention.

FIG. 2 is a view showing a data configuration of task list information according to the embodiment of the present invention.

FIG. 3 is a timing chart illustrating a task processing method according to the embodiment of the present invention.

FIG. 4 is a flowchart illustrating the task processing method according to the embodiment of the present invention.

### DETAILED DESCRIPTION OF THE PREFERRED EMBODIMENTS

Hereinafter, an embodiment applicable to the present invention will be described. Note that the present invention is not limited to the embodiment described below.

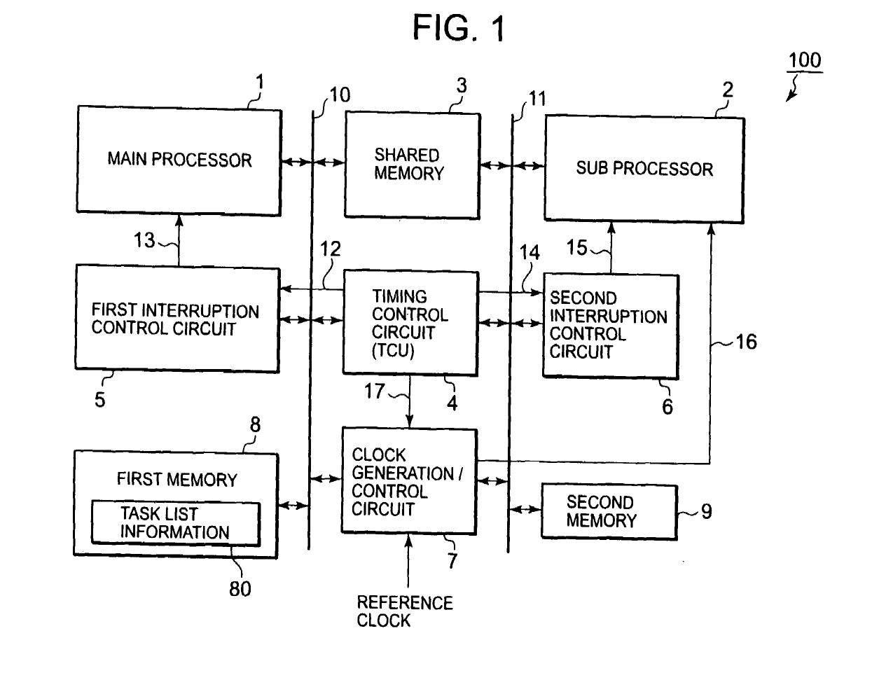

FIG. 1 shows one example of a task processing system 100 according to the embodiment of the present invention. The task processing system 100 is mounted to an electronic device such as a mobile phone.

As shown in FIG. 1, the task processing system 100 includes a main processor 1, a sub processor 2, a shared memory (task storage portion) 3, a timing control circuit (timing control unit (TCU)) 4, a first interruption control circuit 5, a second interruption control circuit 6, a clock generation/control circuit (clock controller) 7, a first memory (task list storage portion) 8, a second memory 9, and the like.

The main processor 1 is connected to the shared memory 3, the timing control circuit 4, the clock generation/control circuit 7, and the first memory 8 via a main processor bus 10.

The main processor 1 controls the timing control circuit 4 and causes the timing control circuit 4 to generate a frame interruption signal (a TCU interruption signal 12 or an interruption signal 13), an event setting interruption signal, a task interruption signal (a TCU interruption signal 14 or an interruption signal 15), or a clock switch signal 17.

Also, the main processor 1 controls the sub processor 2.

Specifically, the main processor 1 determines a task to be executed by the sub processor 2 in each time segment having a predetermined length, and stores task information of the task in the shared memory 3.

Additionally, the main processor 1 determines, by the end of an nth (n is an integer that satisfies n≧1) time segment, a clock frequency (operation frequency), necessary for the sub processor 2 to execute the task in an (n+1)th time segment, based on a required number of cycles for the task to be executed by the sub processor 2 in the (n+1)th time segment. Note that the required number of cycles is stored in the first memory 8. The main processor 1 refers to the first memory 8 to acquire the required number of cycles. The required number of cycles is set in advance based on a processing amount of the task or the like.

Also, the main processor 1 inputs information of the determined clock frequency to the clock generation/control circuit 7. In this manner, the main processor 1 performs setting necessary for clock switching.

The sub processor 2 is connected to the shared memory 3, the timing control circuit 4, the clock generation/control circuit 7, and the second memory 9 via a sub processor bus 11.

A task interruption signal is inputted to the sub processor 2 from the timing control circuit 4 via the second interruption control circuit 6. Also, a clock signal 16 is inputted from the clock generation/control circuit 7.

Upon receipt of the task interruption signal, the sub processor 2 processes the task using the task information stored in the shared memory 3 in synchronization with the clock signal 16.

The shared memory 3 stores the task information of the task to be executed by the sub processor 2.

The timing control circuit 4 generates the frame interruption signal, and inputs the frame interruption signal to the main processor 1 via the first interruption control circuit 5. Specifically, the timing control circuit 4 inputs the TCU interruption signal 12 to the first interruption control circuit 5. Upon receipt of the TCU interruption signal 12, the first interruption control circuit 5 inputs the interruption signal 13 to the main processor 1. In this manner, the frame interruption signal is inputted to the main processor 1.

Additionally, the timing control circuit 4 generates the event setting interruption signal, and inputs the event setting interruption signal to the main processor 1 via the first interruption control circuit 5. Specifically, the timing control circuit 4 inputs the TCU interruption signal 12 to the first interruption control circuit 5. Upon receipt of the TCU interruption signal 12, the first interruption control circuit 5 inputs the interruption signal 13 to the main processor 1. In this manner, the event setting interruption signal is inputted to the main processor 1.

Additionally, the timing control circuit 4 generates the task interruption signal, and inputs the task interruption signal to the sub processor 2 via the second interruption control circuit 6. Specifically, the timing control circuit 4 inputs the TCU interruption signal 14 to the second interruption control circuit 6. Upon receipt of the TCU interruption signal 14, the second interruption control circuit 6 inputs the interruption signal 15 to the sub processor 2. In this manner, the task interruption signal is inputted to the sub processor 2.

The timing control circuit 4 generates the clock switch signal 17 and inputs the clock switch signal 17 to the clock generation/control circuit 7.

Note that the main processor 1 sets timings when the frame interruption signal, the event setting interruption signal, the task interruption signal, and the clock switch signal 17 are generated.

Upon receipt of the TCU interruption signal 12, the first interruption control circuit 5 inputs the interruption signal 13 to the main processor 1.

Upon receipt of the TCU interruption signal 14, the second interruption control circuit 6 inputs the interruption signal 15 to the sub processor 2.

The clock generation/control circuit 7 refers to a reference clock inputted from outside to perform generation and control of the clock signal 16.

The clock generation/control circuit 7 also inputs to the sub processor 2 the clock signal 16 based on the clock frequency inputted from the main processor 1.

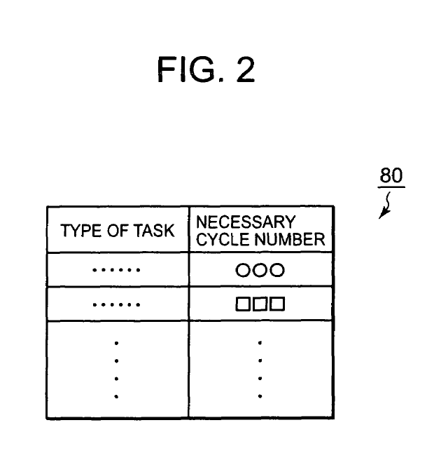

The first memory 8 stores data, programs, and the like necessary for the main processor 1 to execute various processing. Specifically, the first memory 8 stores task list information 80. A data structure of the task list information 80 is shown in FIG. 2. In the task list information 80, a type of tasks to be executed by the sub processor 2, and a required number of cycles of the tasks are stored in association with each other.

The second memory 9 stores data, programs, and the like necessary for the sub processor 2 to execute the tasks.

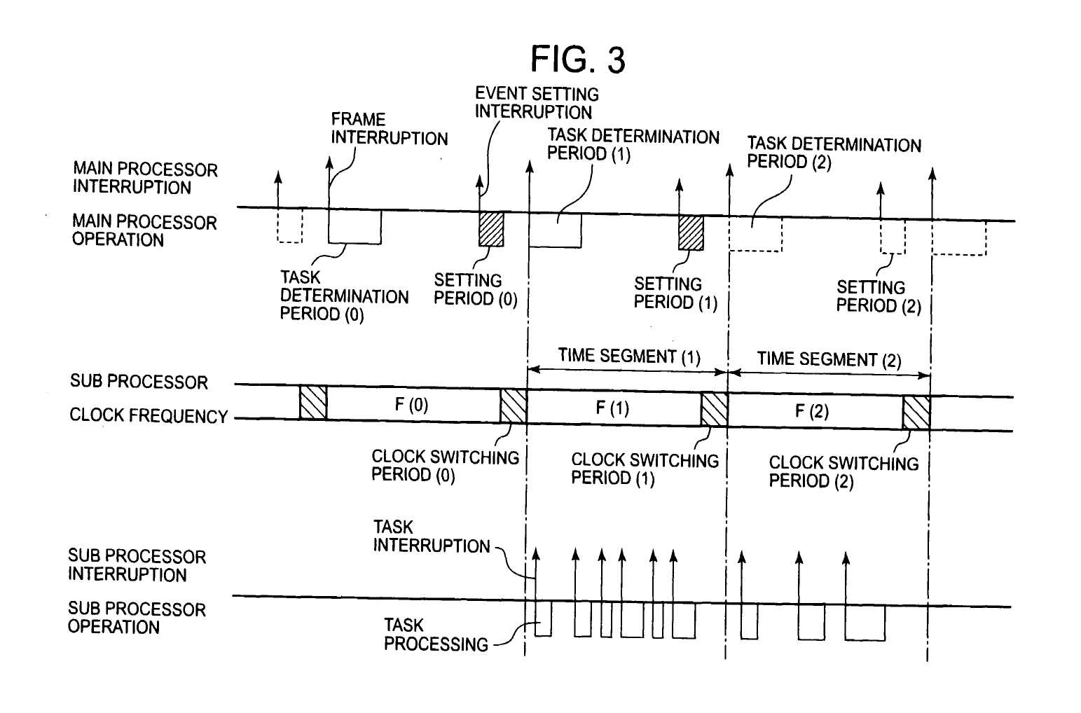

Next, a task processing method for the task processing system 100 according to this embodiment will be described with reference to a timing chart shown in FIG. 3.

As shown in FIG. 3, one time segment stars with the generation of the frame interruption signal and ends with the generation of the next frame interruption signal. The last part of the time segment is a clock switching period. A part of the time segment before the clock switching period is a frame period (F(0), F(1), and F(2) in FIG. 3). In the frame period, task processing is performed by the sub processor 2.

When a first time segment (time segment (1)) is started with the generation of the frame interruption signal, the main processor 1 determines a task to be executed by the sub processor 2 in a second time segment (time segment (2)) (a task determination period (1)).

Next, when the event setting interruption signal is generated, the main processor 1 stores in the shared memory 3 task information of the task determined in the task determination period (1) (a setting period (1)).

In the setting period (1), the main processor 1 determines which signal, and at which timing, the timing control circuit 4 should generate in the time segment (2). Further, in the setting period (1), the main processor 1 determines the clock frequency necessary for the sub processor 2 to execute the task within the time segment (2) based on the required number of cycles of the task to be executed by the sub processor 2 in the time segment (2), and inputs information of the determined clock frequency to the clock generation/control circuit 7. In this manner, the main processor 1 performs the setting necessary for the clock switching.

With the end of the setting period (1) and the generation of the clock switch signal 17, a clock switching period (1) starts. In the clock switching period (1), the clock generation/control circuit 7 performs the clock switching in order to be ready to supply to the sub processor 2 the clock signal 16 based on the clock frequency set by the main processor 1 in the setting period (1).

With the end of the clock switching period (1) and the generation of the frame interruption signal, the time segment (2) starts. The clock generation/control circuit 7 then supplies to the sub processor 2 the clock signal 16 based on the clock frequency switched in the clock switching period (1). In addition, every time the task interruption signal is generated, the sub processor 2 executes the task based on the task information stored in the shared memory 3 in synchronization with the clock signal 16 supplied from the clock generation/control circuit 7.

FIG. 3 shows a case where the clock frequency of the time segment (2) is slower than the clock frequency of time segment (1). As shown in FIG. 3, by the end of the time segment (1), determination is made on the clock frequency based on the required number of cycles of the task to be executed by the sub processor 2 in the time segment (2). In the time segment (2), the clock signal 16 based on the clock frequency is then supplied to the sub processor 2. That is, the clock frequency is determined dynamically according to the processing amount of the task to be executed in each time segment or the like. Therefore, it is possible to securely prevent the supply of the clock signal 16 based on the clock frequency with an operation margin being excessively secured. Accordingly, power consumption can be reduced.

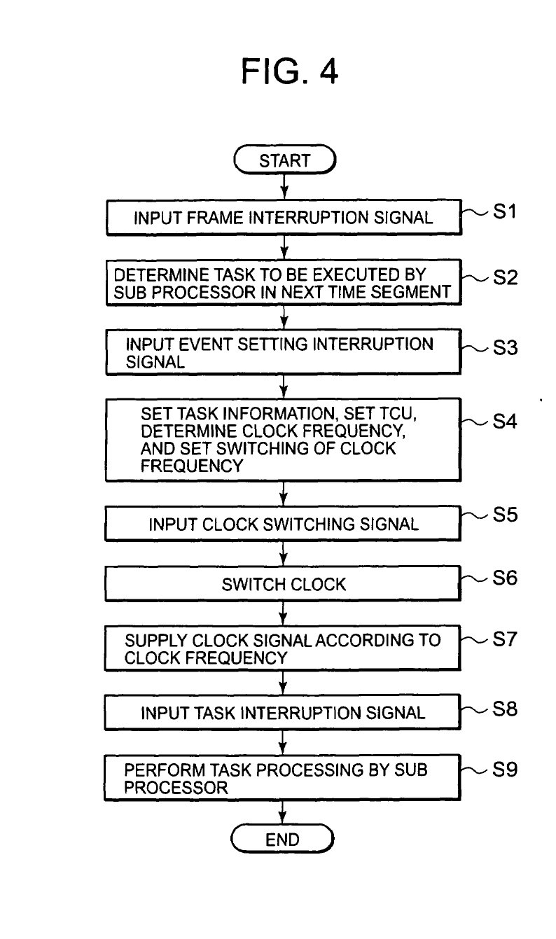

Next, the task processing method for the task processing system 100 according to this embodiment will be described with reference to a flowchart shown in FIG. 4.

First, upon receipt of the frame interruption signal (step S1), the main processor 1 determines the task to be executed by the sub processor 2 in the next time segment and stores the task information of the task in the shared memory 3 (step S2).

Next, upon receipt of the event setting interruption signal (step S3), the main processor 1 stores the task information of the task determined in step S2 in the shared memory 3 (step S4).

In step S4, the main processor 1 determines which signal, and at which timing, the timing control circuit 4 should generate in the next time segment.

Further, in step S4, the main processor 1 determines the clock frequency necessary for the sub processor 2 to execute the task within the next time segment based on the required number of cycles of the task to be executed by the sub processor 2 in the next time segment, and inputs the information of the determined clock frequency to the clock generation/control circuit 7. In this manner, the main processor 1 performs the setting necessary for the clock switching.

Next, upon receipt of the clock switch signal 17 (step S5), the clock generation/control circuit 7 performs the clock switching (step S6).

Next, the clock generation/control circuit 7 supplies to the sub processor 2 the clock signal 16 based on the clock frequency determined in step S4 (step S7).

Next, upon receipt of the task interruption signal (step S8), the sub processor 2 refers to the task information stored in the shared memory 3 and executes the task in synchronization with the clock signal 16 inputted from the clock generation/control circuit 7 (step S9).

In the task processing system 100 and the task processing method according to this embodiment described above, the main processor 1 determines the clock frequency necessary for the sub processor 2 to execute the task within the (n+1)th time segment by the end of the nth time segment. The clock generation/control circuit 7 then supplies to the sub processor 2 in the (n+1)th time segment the clock signal 16 based on the clock frequency determined by the main processor 1 in the nth time segment. That is, the clock frequency is dynamically determined according to the processing amount of the task to be executed in each time segment. Therefore, a flexible response is possible to an increase or decrease of the processing amount in the next time segment. Also, it is possible to further securely prevent supply of the clock signal based on the clock frequency with an operation margin being excessively secured. Accordingly, power consumption can be reduced.

Since a frequency dividing ratio is not determined for every interruption type, an increase in overhead or processing load can be prevented even in a system that frequently performs switching of frequency.

In the clock switching period, the clock generation/control circuit 7 performs the clock switching so as to be ready to supply to the sub processor 2 the clock signal 16 based on the clock frequency set by the main processor 1. In the clock switching period, the sub processor 2 does not perform the task processing. Accordingly, the clock generation/control circuit 7 can securely perform the clock switching before a transition to the next time segment regardless of the processing amount of the task.

In addition, the clock switching period starts with a trigger of a clock switching signal generated by the timing control circuit 4, and then the clock generation/control circuit 7 performs the clock switching. Therefore, the clock generation/control circuit 7 can perform the clock switching at more accurate timing.

Note that the timing at which the main processor 1 determines in the nth time segment the task to be executed by the sub processor 2 in the (n+1)th time segment, or the timing at which the main processor 1 determines in the nth time segment the clock frequency of the clock signal 16 supplied by the clock generation/control circuit 7 in the (n+1)th time segment is not limited to the embodiment described above, and may be any timing by the end of the nth time segment.

Although the inventions has been described above in connection with several preferred embodiments thereof, it will be appreciated by those skilled in the art that those embodiments are provided solely for illustrating the invention, and should not be relied upon to construe the appended claims in a limiting sense.

What is claimed is:

1. A task processing system comprising:
a main processor;
a sub processor being controlled by said main processor; and
a clock controller that supplies a clock signal to said sub processor, wherein
said main processor determines at least one of tasks to be executed by said sub processor in each of a plurality of time segments each having a predetermined length, and determines, by an end of an nth (n is an integer that satisfies n≧1) time segment, an operation frequency necessary for executing said task within an (n+1)th time segment, on the basis of information of a required number of cycles for said task to be executed by said sub processor in said (n+1)th time segment, and
said clock controller supplies, in said (n+1)th time segment, to said sub processor a clock signal according to said operation frequency determined by said main processor in said nth time segment.

2. The task processing system according to claim 1, wherein said main processor inputs, by the end of said nth time segment, to said clock controller said operation frequency necessary for said sub processor to execute said task in said (n+1)th time segment so as to perform setting necessary for clock switching.

3. The task processing system according to claim 1, wherein
said time segment includes a frame period in which said sub processor executes at least one of tasks and a clock switching period subsequent to said frame period, and
said clock controller performs clock switching within said clock switching period of said nth time segment so as to supply, in said (n+1)th time segment, to said sub processor said clock signal according to said operation frequency determined by said main processor.

4. The task processing system according to claim 1, further comprising a task list storage portion that stores a type of said task and said required number of cycles in association with each other.

5. The task processing system according to claim 1, further comprising:
a task storage portion that stores said task for every one of said time segments, wherein
after determining said task to be executed by said sub processor in one of said time segments, said main processor stores said task in said task storage portion.

6. A task processing method for a task processing system, the system including a main processor; a sub processor controlled by said main processor; and a clock controller that supplies a clock signal to said sub processor, the method comprising the steps of:
causing said main processor to determine at least one of tasks to be executed by said sub processor in each of a plurality of time segments each having a predetermined length, and to determine, by an end of an nth (n is an integer that satisfies n≧1) time segment, an operation frequency necessary for executing said task within an (n+1)th time segment, on the basis of information of a required number of cycles for said task to be executed by said sub processor in said (n+1)th time segment; and
causing said clock controller to supply, in said (n+1)th time segment, to said sub processor a clock signal according to said operation frequency determined by said main processor in said nth time segment.

7. The task processing method according to claim 6, wherein said main processor inputs, by the end of said nth time segment, to said clock controller said operation frequency necessary for said sub processor to execute said task in said (n+1)th time segment so as to perform setting necessary for clock switching.

8. The task processing method according to claim 6, wherein
said time segment includes a frame period in which said sub processor executes said task and a clock switching period subsequent to said frame period, and
said clock controller performs clock switching within said clock switching period of said nth time segment so as to supply, in said (n+1)th time segment, to said sub processor said clock signal according to said operation frequency determined by said main processor.

9. The task processing method according to claim 6, further comprising a task list storage portion that stores a type of said task and said required number of cycles in association with each other.

10. The task processing method according to claim 6, wherein
said task processing system further includes a task storage portion that stores said task for every one of said time segments, and
said main processor determines said task to be executed by said sub processor in one of said time segments and then stores said task in said task storage portion.
